(19) United States
(12) Patent Application Publication
(10) Pub. No.: US 2012/0143819 A1
(43) Pub. Date: Jun. 7, 2012

(54) METHOD AND SYSTEM FOR SYNCHRONIZING DATA IN A DATABASE SYSTEM

(75) Inventor: Keng-Woei Tan, San Francisco, CA (US)

(73) Assignee: Salesforce.com, inc., San Francisco, CA (US)

(21) Appl. No.: 13/043,866

(22) Filed: Mar. 9, 2011

Related U.S. Application Data
(60) Provisional application No. 61/418,980, filed on Dec. 2, 2010.

(51) Int. Cl. G06F 17/30

(52) U.S. Cl. 707/626; 707/E17.005

(57) ABSTRACT

A method for synchronizing data in a database system is provided. The method embodiment includes receiving, by a field synchronizing service hosted by a node, an indication identifying a first field of a first record in a database, and receiving an indication identifying a second field of a second record in the database. The first record is of a first object type and the second record is of a second object type different from the first object type. The field synchronizing service can be configured to generate a synchronize relationship between the first field of the first record and the second field of the second record, and to store the synchronize relationship in a mapping table, which is used to synchronize data automatically across different object types.

### CLAIM OF PRIORITY

This application claims the benefit of U.S. Provisional Patent Application 61/418,980 entitled SYNCHRONIZE FIELDS FOR PARENT-CHILD RECORDS, by Keng-Woei Tan, filed Dec. 2, 2010 (Attorney Docket No. 491PROV) the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to synchronizing data in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In a database system, information can be organized and stored in fields, records and/or objects. According to an hierarchical data model, a single fact can be stored in a data field, and a record is a collection of related data fields. In turn, an object is a collection of related records. Viewed in another way, an object can be a data table having many rows and columns, where each row can be a record, and each column in the row can be a field. The object is associated with an object type that is shared by each record and each field in the object. Typically, a database system includes many objects, each of which is associated with a different object type. In some cases, two or more objects can be related to one another hierarchically, that is, in a parent-child relationship. In such a relationship, each parent object can have many children but each child object can only have one parent object.

Information in a database system is dynamic and can be updated, inserted, and/or deleted. When information in a record is changed, i.e., data is updated or inserted, information in another record can be affected, and therefore, the change should be propagated to the affected record so that information in both records is synchronized. Nevertheless, the process of manually synchronizing records can be tedious and error prone when there are hundreds if not thousands of changes and a large number of records affected. Moreover, this issue becomes more complicated when the affected record is in a different object than that of the changed record and when the two objects are of different types.

Accordingly, it is desirable to provide techniques for synchronizing data in a database system.

### BRIEF SUMMARY

In accordance with embodiments, there are provided mechanisms and methods for synchronizing data in a database system. These mechanisms and methods for synchronizing data in a database system enable embodiments to provide the capability to synchronize automatically data fields in differing records stored in a database system without regard to differing object types. The ability of embodiments to provide such technique can allow an end user of the database system to configure custom synchronize relationships between fields in differing records so that the records are synchronized automatically and immediately.

In an embodiment and by way of example, a method for synchronizing data in a database system is provided. The method embodiment includes receiving, by a field synchronizing service hosted by a node, an indication identifying a first field of a first record in a database, and receiving an indication identifying a second field of a second record in the database. The first record is of a first object type and the second record is of a second object type different from the first object type. The field synchronizing service can be configured to generate a synchronize relationship between the first field of the first record and the second field of the second record, and to store the synchronize relationship in a mapping table, which is used to synchronize data automatically across different object types.

While one or more implementations and techniques are described with reference to an embodiment in which techniques for synchronizing data in a database system is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a technique for synchronizing data in a database system according to an embodiment;

FIG. 2 illustrates a representative system for synchronizing data in a database system according to an embodiment;

FIG. 3 illustrates an exemplary service module for synchronizing data in a database system according to an embodiment;

FIG. 4 is an operational flow diagram illustrating a high level overview of a technique for synchronizing data in a database system according to another embodiment;

FIG. 5 illustrates a graphical user interface representing a selector that may be displayed for receiving an indication identifying sync fields according to an exemplary embodiment;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for synchronizing data in a database system.

Typically, a database system includes many objects, each of which is associated with a different object type. In some cases, two or more objects can be related to one another hierarchically, that is, in a parent-child relationship. In such a relationship, each parent object can have many children but each child object can only have one parent object. For example, an Opportunity object can be related to sales opportunities, and each Opportunity record can be related to an organization. The Opportunity object can be associated with a “sales” type, which is also shared by each Opportunity record. A Quote object can be related to sales quotes, and each Quote record can be related to a quote for products or services. The Quote object can be associated with a “quote” type, which is shared by each Quote record. In this example, a parent-child relationship can exist between the Opportunity object and the Quote object. That is, an Opportunity record can be a parent to one or more Quote records because an organization can be offered one or more quotes for products and/or services. When data in either an Opportunity record or a Quote record is changed, data in the other related record could be affected, and therefore also needs to be changed, i.e., the data needs to be synchronized.

To date, there is no effective and/or efficient way of automatically synchronizing data in a database system, and in particular, no effective way of synchronizing data across different object types. Moreover, there is no effective way of synchronizing data in customized user-defined fields. The following exemplary embodiments illustrate mechanisms and methods that can enable an end user of the database system to configure a synchronization relationship between fields regardless of object type, so that an update to a field automatically triggers a synchronization process that updates any related fields. The ability of embodiments to provide such technique can enhance the accuracy and quality of the data in the database.

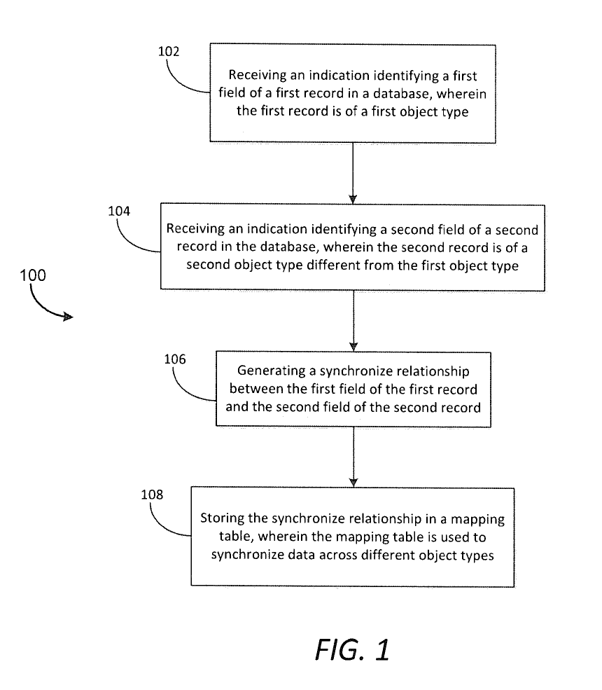

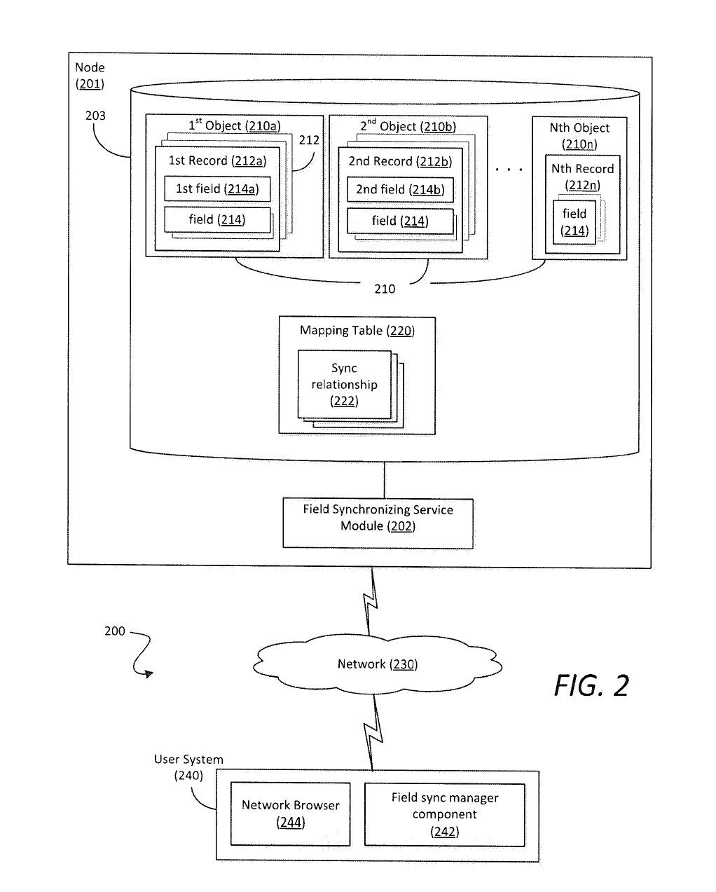

FIG. 1 illustrates a method 100 for synchronizing data in a database system according to an embodiment. FIG. 2 illustrates a representative system 200 for synchronizing data in a database system according to an embodiment. In particular, FIG. 2 illustrates an arrangement of components configured to implement the method 100 of FIG. 1, which also can be carried out in environments other than that illustrated in FIG. 2. In an embodiment, the database system may be implemented as a multi-tenant database system. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Illustrated in FIG. 2 is a field synchronizing service module 202 including components adapted for operating in an execution environment provided by a node 201 and/or multiple nodes as in a distributed execution environment. Exemplary nodes can include desktop computers, servers, networking nodes, notebook computers, PDAs, mobile phones, digital image capture devices, and the like. One example of such a node 201 will be described later in greater detail during reference to later illustrated embodiments. In an embodiment, the field synchronizing service module 202 can be configured to receive and send information from and to a user system 240, e.g., a mobile handheld device or a laptop computer, via a network 230. The network 230 may be a Local Area Network (LAN) and/or a Wide Area Network (WAN) including the Internet. The user system 240 may include an application that allows network communication between the user system 240 and the field synchronizing service module 202. Such an application can be, in an embodiment, a network browser 244 (e.g., Android browser, Internet Explorer, etc.) or the like that is capable of sending and receiving information to and from the node 201 hosting the field synchronizing service module 202.

In an exemplary embodiment, the node 201 hosting the field synchronizing service module 202 can include a data store 203 for storing information and data objects 210. Each data object 210 is associated with an object type that is different from another object, and includes one or more records 212, which in turn includes at least one field 214. For example, a first data object 210a can be an Opportunity object that includes Opportunity records 212. A first Opportunity record 212a can be associated with an entity, e.g., Company A, and a first field 214a in the first record 212a can be associated with a product selected by Company A. For example, the product selected can be 100 laptop computers. In addition, a second object 210b can be a Quote object that includes a second record 212b, e.g., a Quote record, that can be associated with the products offered to Company A. A second field 214b in the Quote record 212b can be associated with the product selected by Company A, i.e., 100 laptop computers. In this example, the Opportunity object type is different from the Quote object type.

When Company A decides to order 200 laptop computers instead, the first field 214a in the Opportunity record 212a can be updated to 200 laptop computers. In turn, the second field 214b in the Quote record 212b should also be updated to reflect that Company A is selecting 200 instead of 100 laptop computers. Nonetheless, as noted above, there is no effective and/or efficient way of automatically synchronizing custom data across different object types in the database system 203.

FIG. 1, as stated above, illustrates a method for synchronizing data in a database system according to an embodiment. In this case, the method 100 can be implemented in the context of the node 201 hosting the information management service module 202, but can also be implemented in any desired environment. With reference to FIG. 1 and FIG. 2, the method begins, in block 102, by receiving an indication identifying a first field, e.g., 214a, of a first record, e.g., 212a, in a database, e.g., 203. In addition, in block 104, an indication identifying a second field, e.g., 214b, of a second record, e.g., 212b, in the database 203 is received. In an embodiment, the indications are received by the field synchronizing service module 202 in the node 201. Moreover, the first record 212a is of a first object type and the second record 212b is of a second object type different from the first object type.

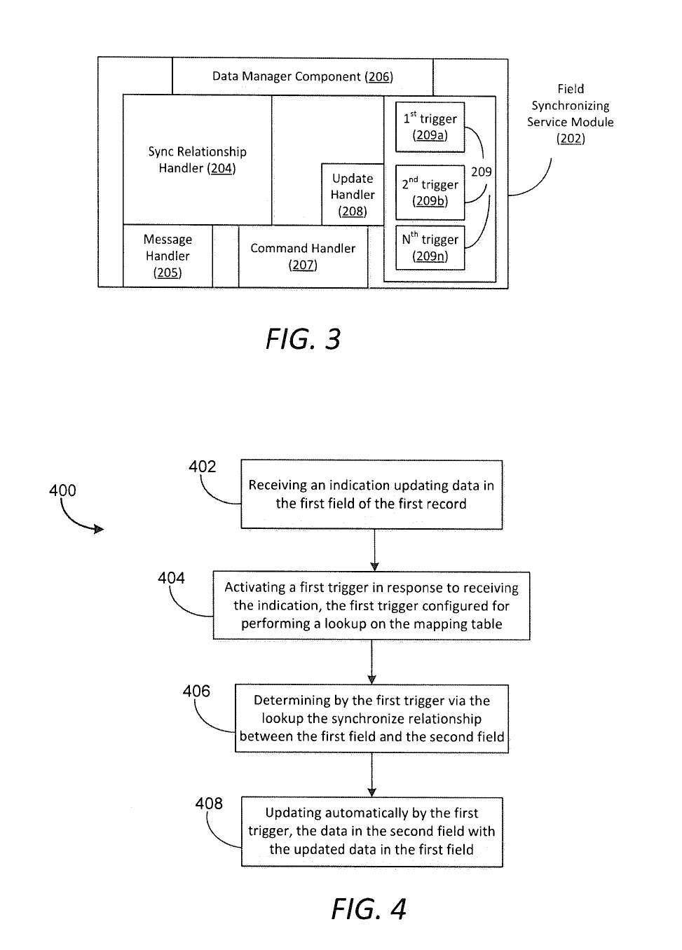

According to an embodiment, the field synchronizing service module 202 includes means for receiving the indications. Illustrated in FIG. 3 is an exemplary field synchronizing service module 202 according to an embodiment. The module 202 includes an arrangement of components configured to implement the method 100 of FIG. 1, which also can be carried out in environments other than that illustrated in FIG. 2 and FIG. 3. Referring to FIGS. 1-3, a sync relationship handler component 204 can be configured for receiving the indications identifying the first 214a and second 214b fields via a command handler component 207. The command handler component 207 can be configured to receive the indications from the user system 240 via the network 230, and to route the indications to the sync relationship handler component 204. The network 230 can support any protocol compatible with a configuration of the field synchronizing service module 202 and/or other components hosted by the node 201 including the field synchronizing service module 202.

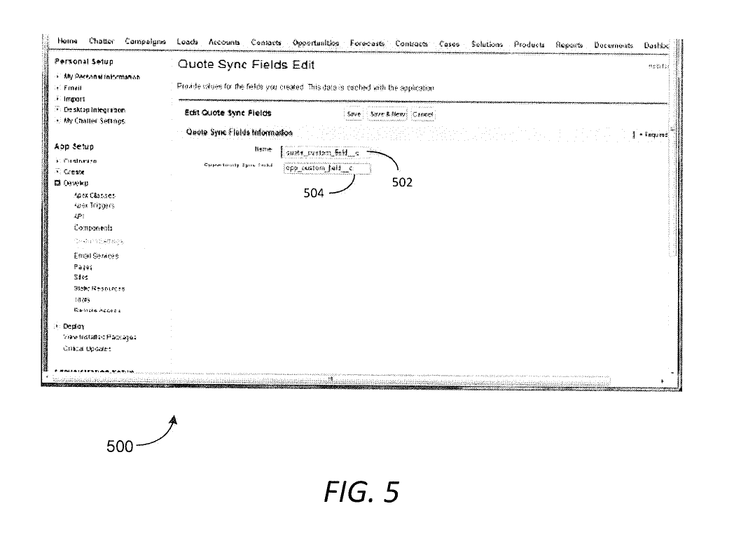

FIG. 5 is a graphical user interface representing a field sync selector 500 that may be displayed by the user system 240 according to an embodiment. The field sync selector 500 can be provided by a field sync manager component 242 coupled to the network browser 240. Alternatively or additionally, the field sync selector 500 can be provided by the sync relationship handler component 204 in the field synchronizing service module 202. As shown, the field sync selector 500 can be associated with a data object, e.g., Quote object, and can provide a first name field 502 into which an end user can enter the indication identifying the first field 214a of the first record 212a. Additionally, the field sync selector 500 can provide a sync field 504 into which the end user can enter the indication identifying the second field 214b of the second record 212b. In an embodiment where the database system 203 is a multi-tenant on-demand database system, the end user can be a tenant. Accordingly, either or both of the first field 214a and the second field 214b can be a customized end user-defined field, such as that provided in a multi-tenant on-demand database system, and the end user tenant can select sync fields independently from a database system administrator.

In an embodiment, when the sync relationship handler component 204 receives the indication identifying the first field 214a, it can be configured to identify at least one candidate field of another record based on at least one attribute of the first field 214a, and to provide that candidate field for possible identification as the second field 214b of the second record 212b. For example, the first field 214a can be associated with a field type and the field synchronizing service module 202 can be configured to identify other fields 214 in other records 212 that are of the same field type. In an embodiment, the field sync selector 500 can be provided by the sync relationship handler component 204 to the user system 240 via a message handler component 205. In this embodiment, the sync field 504 can include a drop down menu (not shown) that includes the candidate field(s) for the end user's selection.

Referring again to FIG. 1, when the indications identifying the first 214a and second 214b fields are received, a synchronize relationship between the first field 214a of the first record 212a and the second field 214b of the second record 212b is generated (block 106). According to an embodiment, the sync relationship handler component 204 can be configured for generating the synchronize relationship between the first field 214a of the first record 212a and the second field 214b of the second record 212b.

According to an embodiment, the sync relationship handler component 204 can be configured to determine whether the first field 214a and the second field 214b satisfy syncing conditions prior to generating the synchronize relationship. For example, in an embodiment, the synchronize relationship can be a bi-directional relationship between the first field 214a of the first record 212a and the second field 214b of the second record 212b. In such a case, a syncing condition can require that paired fields in paired records be exclusive, i.e., that the second field 214b does not have an existing sync relationship with another field in the first record 212a. In an embodiment, the sync relationship handler component 204 can be configured for determining whether the second field 214b has an existing synchronize relationship with another field of the first record 212a, and for proceeding to generate the synchronize relationship when the second field 214b does not have an existing synchronize relationship with another field of the first record 212a.

Alternatively or in addition, another syncing condition can require that paired fields 214a, 214b be of the same field type. In an embodiment, the sync relationship handler component 204 can be configured for comparing field types of the second field 214b and of the first field 214a, and for proceeding to generate the synchronize relationship when the second field type is not different from the first field type. Other syncing conditions exist and/or can be configured, and therefore, are not limited to those discussed above.

When a syncing condition is not satisfied, e.g., the second field 214b has an existing synchronize relationship with another field of the first record 212a and/or the second field type is different from the first field type, the generating step can be terminated and an error indication can be provided. In an embodiment, the sync relationship handler component 204 can be configured for generating and sending the error indication to the user system 240 via the message handler component 205.

Referring again to FIG. 1, when the synchronize relationship is generated, the method includes storing the synchronize relationship in a mapping table (block 108). According to an embodiment, the sync relationship handler component 204 can invoke a data manager component 206 for performing this task. For example, the data manager component 206 can be configured to receive the synchronize relationship 222 from the sync relationship handler component 204, and optionally to process the relationship 222 so that it can be stored in the mapping table 220 in the database system 203. According to an embodiment, the mapping table 220 includes a plurality of synchronize (“sync”) relationships 222 and is used to synchronize data across different object types. In addition to storing the sync relationships 222, the data manager component 206 can also be configured to mark and/or flag the first record 212a and/or the second record 212b to indicate that a sync relationship 222 associated with a field of the first record 212a has been generated and/or stored in the mapping table 220. Such marking/flagging can be of use later during a synchronizing process.

FIG. 4 illustrates a method 400 for synchronizing data in a database system according to another embodiment. Here, the method 400 can be implemented in the context of the field synchronizing service module 202 of FIG. 2 and FIG. 3. The method 400 may, however, be carried out in any desired environment. Referring to FIG. 2, FIG. 3, and FIG. 4, an indication updating data in the first field 214a of the first record 212a is received in block 402. In an embodiment, the field synchronizing service module 202 can include an update handler component 208 configured for receiving the indication updating data in the first field 214a via the command handler component 207.

The updating indication can be received in a number of ways. For example, it can be received from the user system 240 via the network 230. Alternatively or in addition, the updating indication can be received from another component (not shown) in the node 201. For instance, the node 201 can include a data update component (not shown) configured to implement updates to the database 203. When data in the database 203 is changed, the data update component can be configured to generate and transmit a notification including the updating indication to the field synchronizing service module 202.

Referring again to FIG. 4, in response to receiving the updating indication, a first trigger is activated for performing a lookup on the mapping table (block 404). In an embodiment, each data object 210 type in the database system 203 can be associated with a trigger 209 in the field synchronizing service module 202. For example, a first trigger 209a can be associated with a first type of the first data object 210a and each of its records 212, and a second trigger 209b can be associated with a second type of the second data object 210b and each of its records 212. Accordingly, when the updating indication is received, the update handler component 208 can be configured to determine that the first trigger 209a is associated with the updated first field 214a of the first record 212a, and can be configured for activating the first trigger 209a to perform a lookup on the mapping table 220. In another embodiment, more than one data object 210 can be associated with more than one trigger 209. Alternatively or in addition, one trigger 209 can be implemented to perform lookups on the mapping table 220 regardless of object type.

In an embodiment described above, a record, e.g., the first record 212a, can be marked/flagged to indicate that a synchronization relationship 222 associated with a field, e.g., the first field 214a, of the record 212a has been generated and/or stored in the mapping table 220. In this case, prior to activating the first trigger 209a, the update handler component 208 can be configured to determine that the first record 212a is marked/flagged, and to activate the first trigger 209a in response to making such a determination. Conversely, when a record, e.g., an Nth record 212n, is not marked/flagged, a synchronization relationship 222 associated with a field of the record 212n has not been generated and/or stored in the mapping table 220. Accordingly, the update handler component 208, upon determining that the record 212n is not marked, will not activate the associated trigger, e.g., an Nth trigger 209n, to perform a lookup on the mapping table 220. A futile table lookup can be avoided, thereby reducing inefficiency and cost.

Referring again to FIG. 4, when the first trigger 209a is activated, the method continues by determining the synchronize relationship 222 between the first field 214a and the second field 214b via the mapping table 220 lookup (block 406). In an embodiment, because the first trigger 209a is associated with the type of the first object 210a, it can be configured to perform a lookup on the mapping table 220 pertaining specifically to the first object 210a. Based on the updating indication, which can identify the first record 212a and the updated first field 214a, the first trigger 209a can be configured to narrow its search to the first record 212a and then to the first field 214a. In this manner, the first trigger 209a can identify the synchronize relationship 222 between the first field 214a and the second field 214b.

Referring again to FIG. 4, once the synchronize relationship 222 is determined, the data in the second field 214b is automatically updated with updated data in the first field 214a (block 408). According to an embodiment, the first trigger 209a can invoke the data manager component 206 to update the data in the second field 214b. In an embodiment, the updating indication can include updated data of the first field 214a, and the first trigger 209a can submit to the data manager component 206 an UPDATE command including an identifier associated with the second field 214b and the updated data. The data manager component 206 can then be configured to process the command against the database 203, thereby synchronizing the data between the two fields 214a, 214b.

In another embodiment, the first trigger 209a can submit to the data manager component 206 a GET command including an identifier associated with the first field 214a received, for example, in the updating indication. The data manager component 206 can be configured to process the command against the database 203, thereby retrieving and returning the updated data in the first field 214a. Once the updated data is retrieved, the first trigger 209a can submit to the data manager component 206 an UPDATE command including an identifier associated with the second field 214b and the updated data, and the data manager component 206 can synchronize the data between the two fields 214a, 214b.

As noted above, the synchronize relationship can be a bi-directional relationship between the first field 214a and the second field 214b. Accordingly, an update to data in the second field 214b can initiate an update to the data in the first field 214a. In an embodiment, the method 400 of FIG. 4 can be similarly applied when an indication updating data in the second field 214b of the second record 212b is received. In this case, a second trigger 209b is activated to perform a lookup on the mapping table 220. According to an embodiment, the second trigger 209b can be associated with a type of the second object 210b. In a manner described above corresponding to the first trigger 209a, the second trigger 209b can determine the synchronize relationship 222 between the first field 214a and the second field 214b based on the mapping table lookup, and then can update automatically the data in the first field 214a with updated data in the second field 214b.

### System Overview

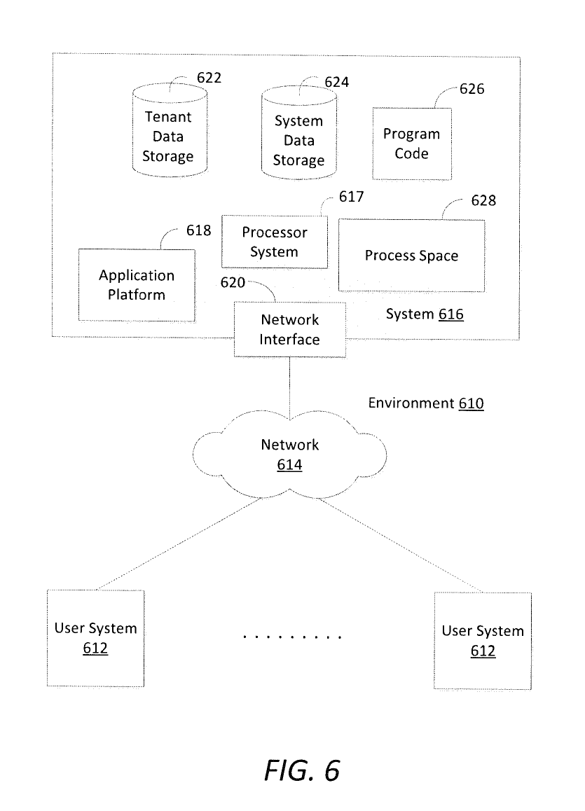

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

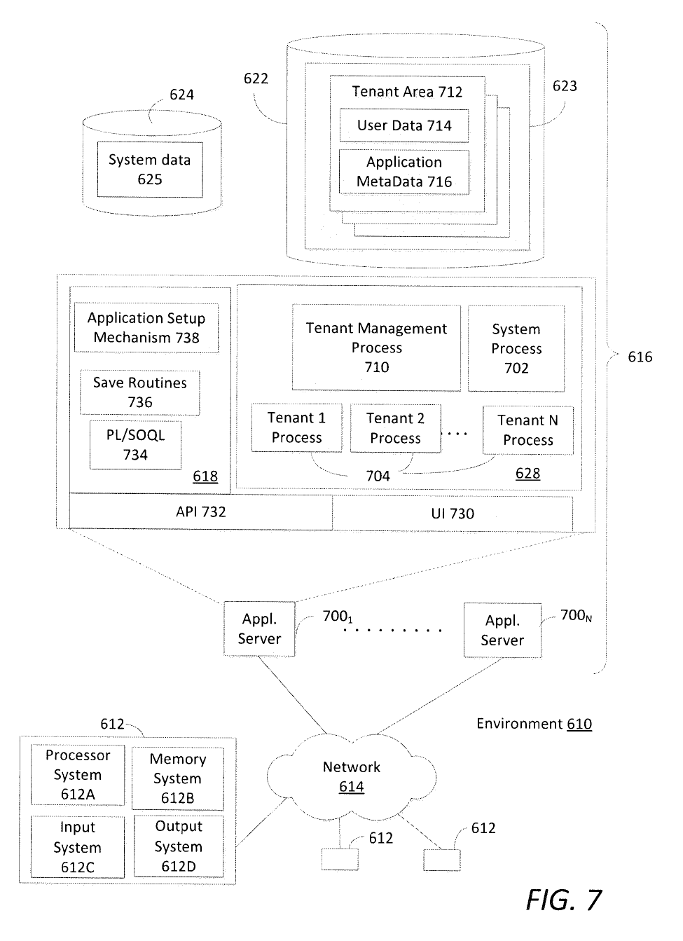

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 7001-700N, system process space 702, tenant process spaces 704, tenant management process space 710, tenant storage area 712, user data storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 7001-700N, an application platform 618, tenant data storage 622, and system data storage 624. Also shown is system process space 702, including individual tenant process spaces 704 and a tenant management process space 710. Each application server 7001-700N may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user data storage 714 and application metadata 716 might be similarly allocated for each user. For example, a copy of a user's most recently used (MRU) items might be stored to user data storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data 623 and the system data 625 may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 716 for the subscriber making the invocation and executing the metadata as an application in a virtual machine.

Each application server 7001-700N may be communicably coupled to database systems, e.g., having access to system data 625 and tenant data 623, via a different network connection. For example, one application server 7001 might be coupled via the network 614 (e.g., the Internet), another application server 700N-1 might be coupled via a direct network link, and another application server 700N might be coupled by yet a different network connection. Transfer Control Protocol and Internet Protocol (TCP/IP) are typical protocols for communicating between application servers 7001-700N and the database system. However, it will be apparent to one skilled in the art that other transport protocols may be used to optimize the system depending on the network interconnect used.

In certain embodiments, each application server 7001-700N is configured to handle requests for any user associated with any organization that is a tenant. Because it is desirable to be able to add and remove application servers from the server pool at any time for any reason, there is preferably no server affinity for a user and/or organization to a specific application server 7001-700N. In one embodiment, therefore, an interface system implementing a load balancing function (e.g., an F5 Big-IP load balancer) is communicably coupled between the application servers 7001-700N and the user systems 612 to distribute requests to the application servers 7001-700N. In one embodiment, the load balancer uses a least connections algorithm to route user requests to the application servers 7001-700N. Other examples of load balancing algorithms, such as round robin and observed response time, also can be used. For example, in certain embodiments, three consecutive requests from the same user could hit three different application servers 7001-700N, and three requests from different users could hit the same application server 7001-700N. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 7001-700N to request and update system-level and tenant-level data from system 616 that may require sending one or more queries to tenant data storage 622 and/or system data storage 624. System 616 (e.g., an application server 7001 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “CUSTOM ENTITIES AND FIELDS IN A MULTI-TENANT DATABASE SYSTEM,” and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for synchronizing data in a database system, the method comprising:
receiving, by a field synchronizing service hosted by a node, an indication identifying a first field of a first record in a database, wherein the first record is of a first object type;
receiving, by the field synchronizing service, an indication identifying a second field of a second record in the database, wherein the second record is of a second object type different from the first object type;
generating, by the field synchronizing service, a synchronize relationship between the first field of the first record and the second field of the second record; and
storing, by the field synchronizing service, the synchronize relationship in a mapping table, wherein the mapping table is used to synchronize data across different object types.

2. The method of claim 1 wherein receiving the indications identifying the first and second fields comprises receiving the indications over a network, wherein the network is at least one of a public and a private network.

3. The method of claim 1 wherein the database system is a multi-tenant on-demand database system.

4. The method of claim 1 wherein prior to generating the synchronize relationship, the method further comprising:
determining whether the second field has an existing synchronize relationship with another field of the first record;
terminating the generating step and providing an error indication when the second field has an existing synchronize relationship with another field of the first record; and
proceeding to generate the synchronize relationship when the second field does not have an existing synchronize relationship with another field of the first record.

5. The method of claim 1 wherein the first field is of a first field type and the second field is of a second field type and wherein prior to generating the synchronize relationship, the method further comprising:
comparing the second field type and the first field type;
terminating the generating step and providing an error indication when the second field type is different from the first field type; and
proceeding to generate the synchronize relationship when the second field type is not different from the first field type.

6. The method of claim 1 wherein prior to receiving the indication identifying the second field, the method further comprising:
in response to receiving the indication identifying the first field, identifying at least one candidate field of another record based on at least one attribute of the first field; and
providing the at least one candidate field, wherein the at least one candidate field is provided for possible identification as the second field of the second record.

7. The method of claim 1 wherein the synchronize relationship is a bi-directional relationship between the first field of the first record and the second field of the second record.

8. The method of claim 1 further comprising:
receiving, by the field synchronizing service, an indication updating data in the first field of the first record;
activating a first trigger in response to receiving the indication, the first trigger configured for performing a lookup on the mapping table;
determining, by the first trigger via the lookup, the synchronize relationship between the first field and the second field; and
updating automatically by the first trigger, the data in the second field with updated data in the first field.

9. The method of claim 8 further comprising:
marking the first record to indicate that a synchronization relationship associated with a field of the first record is at least one of generated and stored in the mapping table; and
determining, prior to activating the first trigger and in response to receiving the indication updating data in the first field, that the first record is marked, wherein activating the first trigger is in response to receiving the indication and in response to determining that the first record is marked.

10. The method of claim 8 wherein the synchronize relationship is a bi-directional relationship between the first field of the first record and the second field of the second record, the method further comprising:
receiving, by the field synchronizing service, an indication updating data in the second field of the second record;
activating a second trigger in response to receiving the indication, the second trigger configured for performing a lookup on the mapping table;
determining, by the second trigger via the lookup, the synchronize relationship between the first field and the second field; and
updating automatically by the second trigger, the data in the first field with updated data in the second field.

11. The method of claim 10 wherein the first trigger is associated with the first object type and the second trigger is associated with the second object type.

12. The method of claim 1 wherein at least one of the first field and the second field is a customized user-defined field in a multi-tenant on-demand database system.

13. The method of claim 1 wherein the database system is a multi-tenant on-demand database system and wherein the indication identifying the first field of the first record and the indication identifying the second field of the second record are received from an end user tenant of the multi-tenant on-demand database system.

14. A machine-readable medium carrying one or more sequences of instructions for synchronizing data in a database system, which instructions, when executed by one or more processors, cause the one or more processors to carry out the steps of:
receiving, by a field synchronizing service hosted by a node, an indication identifying a first field of a first record in a database, wherein the first record is of a first object type;
receiving, by the field synchronizing service, an indication identifying a second field of a second record in the database, wherein the second record is of a second object type different from the first object type;
generating, by the field synchronizing service, a synchronize relationship between the first field of the first record and the second field of the second record; and
storing, by the field synchronizing service, the synchronize relationship in a mapping table, wherein the mapping table is used to synchronize data across different object types.

15. An apparatus for synchronizing data in a database system, the apparatus comprising:
a processor; and
one or more stored sequences of instructions which, when executed by the processor, cause the processor to carry out the steps of:
receiving, by a field synchronizing service hosted by a node, an indication identifying a first field of a first record in a database, wherein the first record is of a first object type;
receiving, by the field synchronizing service, an indication identifying a second field of a second record in the database, wherein the second record is of a second object type different from the first object type;
generating, by the field synchronizing service, a synchronize relationship between the first field of the first record and the second field of the second record; and
storing, by the field synchronizing service, the synchronize relationship in a mapping table, wherein the mapping table is used to synchronize data across different object types.

16. A method for transmitting code for synchronizing data in a database system, the method comprising:
transmitting code to receive, by a field synchronizing service hosted by a node, an indication identifying a first field of a first record in a database, wherein the first record is of a first object type;
transmitting code to receive, by the field synchronizing service, an indication identifying a second field of a second record in the database, wherein the second record is of a second object type different from the first object type;
transmitting code to generate, by the field synchronizing service, a synchronize relationship between the first field of the first record and the second field of the second record; and
transmitting code to store, by the field synchronizing service, the synchronize relationship in a mapping table, wherein the mapping table is used to synchronize data across different object types.
